(19) United States
(12) Patent Application Publication
(10) Pub. No.: US 2008/0190857 A1
(43) Pub. Date: Aug. 14, 2008

(54) System and Methods of Producing Membranes

(75) Inventors: Roberto Beretta, Milano (IT); Nicholas A. Grippi, Wayne, NJ (US)

Correspondence Address: MICHAEL BEST & FRIEDRICH LLP, 100 E WISCONSIN AVENUE, Suite 3300, MILWAUKEE, WI, 53202, US

(73) Assignee: CASCADE MEDICAL ENTRPRISES, LLC, Wayne, NJ (US)

(21) Appl. No.: 11/909,191

(22) PCT Filed: Mar. 22, 2006
(86) PCT No.: PCT/US2006/010525

§ 371 Date: Mar. 3, 2008

Related U.S. Application Data
(60) Provisional application No. 60/664,004, filed on Mar. 22, 2005.

(51) Int. Cl. B04B 9/00; B03D 3/02

(52) U.S. Cl. 210/696; 494/46; 210/738

(57) ABSTRACT

An apparatus and method of forming a solid-fibrin web. The apparatus includes a centrifuge (600) having a housing (604), and actuator (648), a wheel (660), and a flange (664). The housing includes a recessed area (616) and a base (608) supportable on a surface. The wheel is coupled to the actuator and extends into the recessed area and is adapted to contact a first end of a container (620). The flange extends into the recessed area opposite the wheel and defines an adjustable distance between the wheel and the flange. The flange is adapted to contact a second end of the container and the actuator is operable to rotate the container. The container is oriented substantially parallel with respect to the base.

### RELATED APPLICATIONS

This application claims priority to provisional patent application Ser. No. 60/664,004, filed on Mar. 22, 2005.

### SUMMARY

In one embodiment, the invention provides a centrifuge comprising a base supportable on a surface, a roller supported by the base and arranged to receive a container, the roller defines an axis oriented substantially parallel with respect to the base, and an actuator operable to actuate the roller to rotate the container.

In another embodiment, the invention provides a centrifuge comprising a housing, an actuator, a wheel, and a flange. The housing includes a recessed area and a base supportable on a surface. The wheel is coupled to the actuator and extends into the recessed area and adapted to contact a first end of a container. The flange extends into the recessed area opposite the wheel and defining an adjustable distance between the wheel and the flange, the flange adapted to contact a second end of the container, the actuator operable to rotate the container, the container oriented substantially parallel with respect to the base.

In another embodiment, the invention provides a method of preparing a solid-fibrin web. The method comprises the acts of separating plasma from blood with a first centrifuge, contacting the plasma with a coagulation activator in a container, and activating a roller supported by a second centrifuge to concurrently rotate the container and coagulate the plasma to form the solid-fibrin web, the solid-fibrin web being suitable for regenerating body tissue in a living organism, the container being arranged in a substantially horizontal plane.

### BRIEF DESCRIPTION OF THE DRAWINGS

FIG. 1 is a perspective view of a device which may be employed in an axial-centrifugation system embodying one aspect of the invention.

FIG. 2 is a cross-sectional view of the device and contents shown in FIG. 1.

FIG. 3 is a cross-sectional view of the device and contents shown in FIG. 1 during an initial centrifugation.

FIG. 4 is a cross-sectional view of the device and contents shown in FIG. 1 after the initial centrifugation has stopped.

FIG. 5 is a cross-sectional view of the device and contents shown in FIG. 1 during a secondary centrifugation.

FIG. 6 is a perspective view of a variation of the device shown in FIG. 1, wherein the radius of the secondary densification chamber is greater than the radius of the primary cell-separation chamber.

FIG. 7 is a cross-sectional view of a variation of the system shown in FIG. 1, in which concentric chambers are employed.

FIG. 8 is a cross-sectional view of the device and contents shown in FIG. 7 during an initial centrifugation.

FIG. 9 is a cross-sectional view of the device and contents shown in FIG. 7 after the initial centrifugation has stopped.

FIG. 10 is a cross-sectional view of the device and contents shown in FIG. 7 during a secondary centrifugation.

FIG. 11 is a cross-sectional view of a system employing a hydrophobic membrane.

FIG. 12 is an enlarged portion of FIG. 11.

FIG. 13 is a cross-sectional view of a portion of a wall of the densification chamber having a fabric reinforcement.

FIG. 14 is a cross-sectional view of a variation of the wall of FIG. 13, in which the wall is provided with bumps.

FIG. 15 is a cross-sectional view of a variation of the wall of FIG. 13, in which the wall is provided with grooves.

FIG. 16 shows a densification chamber lined with a removable film having tabs, the film facilitating membrane removal.

FIG. 17 shows a membrane having perforations to facilitate tearing.

FIG. 18 is a perspective view partially in section of a rotor medical device embodying another aspect of the invention.

FIG. 19 is a bottom plan view of a densification chamber having one or more solid ribs on the interior wall.

FIG. 20 shows examples of a mold oriented for use in a radial centrifugation system (as shown in FIG. 20(a)) and a mold oriented for use in an axial centrifugation system (as shown in FIG. 20(b)).

FIG. 21 shows a portion of a device having a mold, in which a funnel and a runner are employed to promote cavity filling.

FIG. 22 shows a portion of a device having a mold, in which vent holes are employed to allow for proper escape of gases and liquids.

FIG. 23 is a perspective view, shown partially in cross-section, of a device having molds, vanes dividing two chambers and a vent.

FIG. 24 is a top plan view of the device of FIG. 23.

FIG. 25 is a top plan view of a device having molds, vanes dividing three unequal chambers and a vent.

FIG. 26 is a top plan view of a modification of the device of FIG. 25, in which the molds are shown being integral, connected and extending from the device and vanes divide three equal chambers.

FIG. 27 is a cross-sectional side view of a portion of any of the devices shown in FIGS. 23-26 after platelet-rich plasma has been introduced into at least one chamber, but before the device has been centrifuged.

FIG. 28 is a cross-sectional side view of a portion of the device shown in FIG. 27 just after the device has been centrifuged.

FIG. 29 is a cross-sectional side view of a portion of the device shown in FIG. 27 at full centrifugation, in which the platelet-rich plasma has entered at least one of the molds.

FIG. 30 is a cross-sectional view showing a plastic alternative, e.g., glass affixed to the bottom.

FIG. 31 is a cross-sectional view showing a plastic alternative, e.g., glass spheres glued or hot stalked to the bottom.

FIG. 32 is a perspective view of a moldable insert embodying the invention.

FIG. 33a is a perspective view of a primary container wrapped in a sterile film and housed by a carrier.

FIG. 33b is an exploded view of FIG. 33a showing a collar on the primary tube.

FIG. 34 is a side view of a centrifuge according to one embodiment of the invention.

FIG. 35 is a front view of the centrifuge of FIG. 34.

FIG. 36 is a side view of a centrifuge according to another embodiment of the invention.

FIG. 37 is a side view of a model of the centrifuge of FIG. 36.

FIG. 38 is a top plan view of a model of the centrifuge illustrated in FIG. 37.

FIG. 39 is a perspective view of a model of the centrifuge illustrated in FIG. 37.

FIG. 40 is a side view of the centrifuge illustrated in FIG. 36 including a multi-chambered container.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

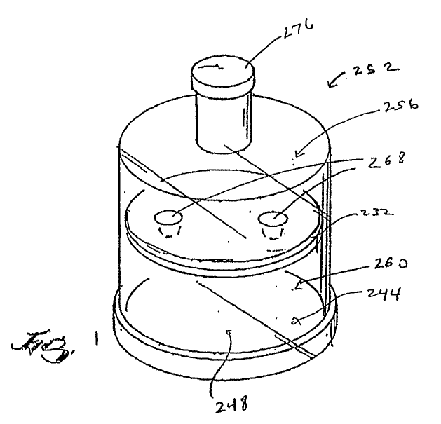

In one embodiment of the invention, known as the large axial spin, membranes, e.g., membranes up to, but not limited to, 1000 mm in diameter may be obtained. FIGS. 1-5 illustrate this embodiment.

In this embodiment, both the primary and secondary centrifuge operations are performed in one axial spin container. The secondary chamber may be partitioned to yield multiple discrete area membranes of large area. This partitioning is discussed in more detail below.

This system comprises a centrifuge (not shown) and a device 252 which can be inserted therein and which is shown in FIGS. 1-5. The device 252 has two chambers, namely, a primary or upper chamber 256 and a secondary or lower chamber 260 in fluid communication with one another. The primary or upper chamber 256 acts as the cell-separation chamber, while the secondary or lower chamber 260 acts as the densification chamber. The device 252, as shown in FIGS. 1-5, also includes a diaphragm 264 having at least one opening, aperture or vent defined therein. The diaphragm 264 separates the two chambers 256, 260. The opening, aperture or vent 268 provides fluid communication between the primary chamber 256 and the secondary chamber 260. The diaphragm 264 may, for example, be made from a plastic, ceramic or glass.

The primary chamber 256 may contain a separation medium 272. Any of the separating mediums 272 discussed above may be used in conjunction with the system, although specific examples of separating mediums 272 may include at least one of silicone gels, polyester gels, thixotropic gels and combinations thereof. More specifically, the vent or vents 268 of the diaphragm 264 may be plugged with the separating medium 272 (e.g., a gel) in an amount sufficient to block the vent or vents 268 and provide separation of the red blood cells from the plasma after a first centrifugation. The primary chamber 256 receives whole blood from a patient, usually through pierceable stopper 276 or other suitable device such as a lined screw cap, like a bottle cap. In FIGS. 1-5, the system is shown as having a pierceable stopper 276 through which blood may be introduced into the upper chamber 256. The primary chamber 256 may also contain an anticoagulant 232. The chamber 256 may also be evacuated to allow vacuum collection of the specimen by standard venipuncture. The secondary chamber 260 may contain a coagulation activator 244, and may contain one or more of the secondary active agents 248 discussed above.

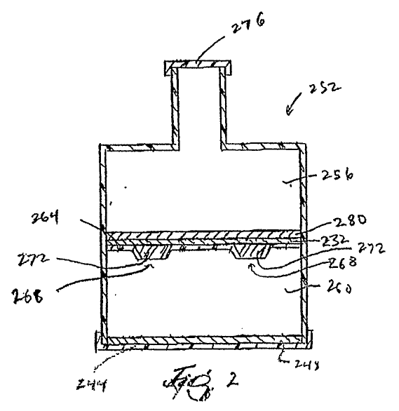

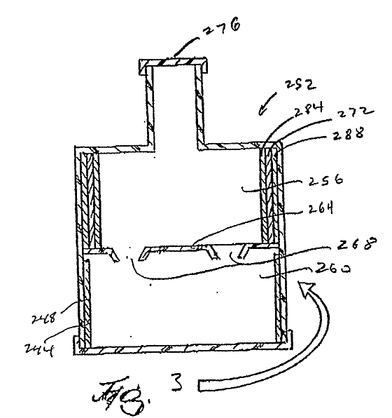

After blood 280 has been collected into the upper chamber 256 as shown in FIG. 2, the device 252 is centrifuged axially at the proper g force to affect cell separation, namely, separation of red blood cells 288 from the platelet-rich plasma 284. Typical g forces used to affect cell separation may include 500 to 15,000×g for a predetermined time, such as, greater than 5 minutes. Preferably, initial centrifugation takes place at about 1000-1500×g for about 5 to 15 minutes. This applies to all of the embodiments pertaining to membranes set forth herein. The initial centrifugation moves the separation medium 272 from its position blocking the vents 268 to the interface. For example, a thixotropic gel 272 may maintain separation of the two chambers 256, 260 during filling of the primary chamber 256 with blood 280, but will move during initial centrifugation to effect cell separation and to open the connecting fluid path to separate the two chambers 256, 260. The gel 272 flows radially, outwardly and upwardly so that gel 272 does not fall into the bottom chamber 260. The result of the initial centrifugation is shown in FIG. 3. Due to the relative densities of the platelet-rich plasma 284, separation medium 272 and red blood cells 288, the centrifugation will position these three substances in the previously-mentioned order from inside of the primary chamber 256 to the outside of the primary chamber 256 as shown in FIG. 3. In the figures, and as used herein, PRP stands for platelet-rich plasma and RBC stands for red blood cells.

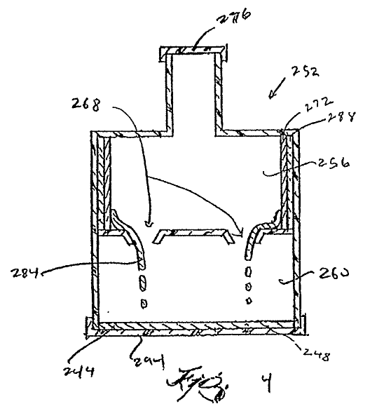

Subsequently, the initial centrifugation is stopped, the result of which is shown in FIG. 4. Upon terminating centrifugation, the platelet-rich plasma 284 drains through the vents 268 by gravity into the lower chamber 260, where it is mixed with the clot activator 244 and secondary active agents 248 if present. The separation medium 272, however, will stay in place, thereby preventing the red blood cells 288 from entering the second chamber 260 through the vents 268. The vents 268 may be funnel shaped to ensure that the g force exerted makes all the platelet-rich plasma 284 flow into the secondary, densification chamber 260.

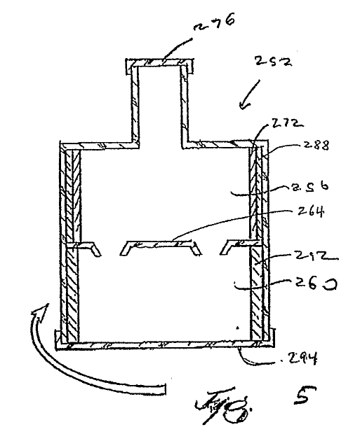

As shown in FIG. 5, centrifugation is restarted at the proper g force, e.g., 500-15,000×g, and a large membrane 292 is formed on the outer circumference of the lower chamber 260. Preferably, centrifugation takes place at about 2500 to 10,000×g for about 20 minutes to an hour depending on the density of the membrane sought to be achieved. It should be noted that the separation medium 272 and red blood cells 288 tend to stay in the same position during secondary centrifugation. This system allows for concurrent centrifugation and coagulation, which results in the large platelet/fibrin membrane 292. The device 252 also has a bottom 294, which may be removable, thereby allowing for the membrane to be easily extracted from the device.

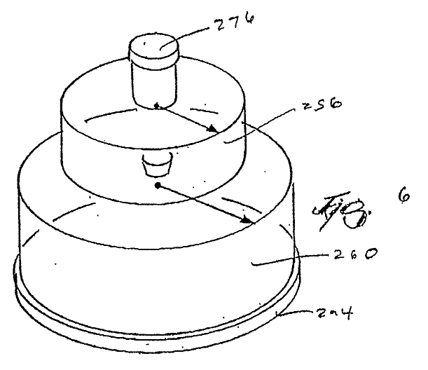

The following systems and devices are variations of the basic system shown in FIGS. 1-5. For example, the cell separation or primary chamber 256 may have a different radius than the densification or secondary chamber 260. As shown in more detail in FIG. 6, the radii of the upper and lower chambers may be different, which allows for different g forces to be exerted at the circumference wall. Consequently, one speed rpm yields two different g forces, thereby simplifying motor and programming. More particularly, providing the chambers with different radii eliminates the need for multiple speed programming due to the different g force at the same rpm.

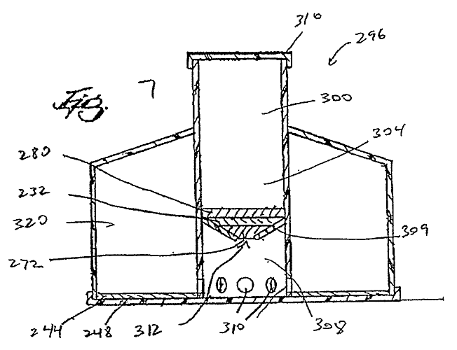

FIGS. 7-10 illustrate a variation of the system shown in FIGS. 1-5, in which concentric cylinders are used. The system 296 includes a primary tube 300 having an upper portion 304 separated from a lower portion 308 by a diaphragm or other separator 309. The primary tube 300 acts as the cell-separation chamber. At least one vent, hole or aperture 312 provides fluid communication between the upper 304 and lower portions 308 of the primary tube 300. Again, blood may be introduced into the primary tube 300 through one or more pierceable stoppers 316 or other suitable device. The primary tube 300 may contain an anticoagulant 232 to prevent premature clotting of the blood. A separation medium 272 prevents the blood from flowing from the upper portion 304 of the primary tube 300 into the lower portion 308 through at least one vent 312. The lower portion 308 may also have voids, holes or apertures 310, through which a liquid may flow. Densification of the platelet-rich plasma 284 takes place in a secondary, concentric tube 320. The secondary tube 320 may contain one or more of the coagulation activators 244 discussed above and/or one or more secondary active agents.

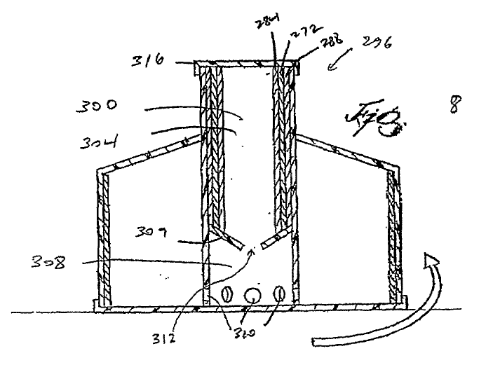

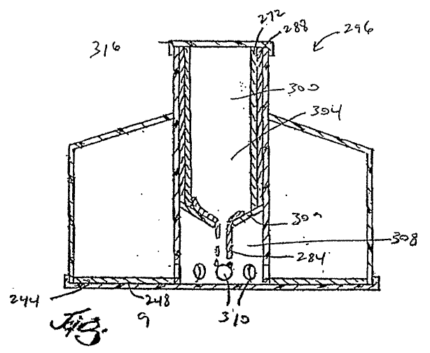

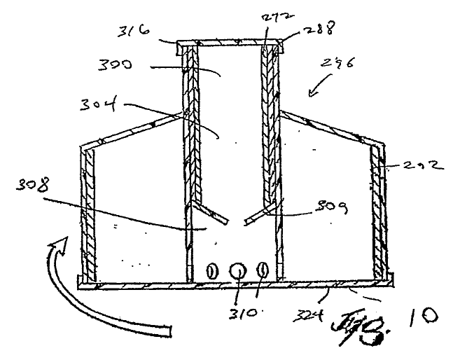

Initially, centrifugation separates the blood into plasma and red blood cells, which are separated by the separating medium as discussed above and shown in FIG. 8. Initial centrifugation generally takes place at greater than about 1000×g for greater than about 10 minutes. Once the centrifugation is stopped, as shown in FIG. 9, the platelet-rich plasma 284 will fall into the lower portion 308 of the primary tube 300 through the one or more vents 312, and the red blood cells 288 will be trapped in the upper portion 304 of the primary tube 300 by the separation medium 272. At least one void 310 is provided in the wall of the lower portion 308 of the primary tube 300. The system is subsequently centrifuged as shown in FIG. 10, thereby resulting in at least a portion of the platelet-rich plasma 284 leaving the lower portion 308 through voids 310 of the primary tube 300 and entering into the secondary tube 320. Again, the red blood cells 288 will remain trapped by the separation medium 272 in the upper portion 304 of the primary tube 300. As shown in FIGS. 7-10, the secondary tube contains at least one clot activator 244, into which the platelet-rich plasma 284 will come into contact. Consequently, this variation also provides for concurrent coagulation and centrifugation, which forms the membrane 292. This variation allows for a more compact unit and reduces plastic usage. The device 296 may also have a removable bottom 324 to facilitate removal of the membrane.

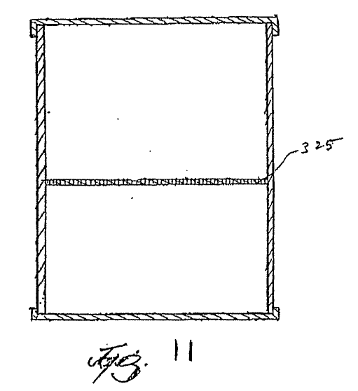

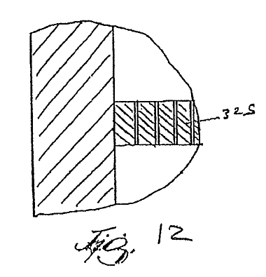

As another alternative, a hydrophobic membrane 325 may be employed instead of a separating medium 272. The hydrophobic membrane 325 may be used in any of the systems using a separating medium. The hydrophobic membrane 325 only permits the flow of the platelet-rich plasma at a set g force, eliminating the need for a separating medium. In other words, instead of using a diaphragm having holes blocked by gel, a hydrophobic membrane may be used as shown in FIGS. 11-12. When using a membrane, the lower chamber and the upper chamber may have the same radii as shown in FIG. 1, or the two chambers may have different radii, one example of which is shown in FIG. 6. In addition, the hydrophobic membrane 325 may be applied to the concentric design shown in FIG. 7.

The hydrophobic membrane 325 substantially prevents an aqueous liquid, such as platelet-rich plasma, from flowing through its pores until a set hydrostatic pressure is reached. Examples of hydrophobic membranes 325 may include, but are not limited to, polypropylene, polycarbonate, cellulose, polyethylene, TEFLON® of Dupont and combinations thereof. Other examples include Millipore® membranes and screens manufactured by Millipore, or Nucleopore® membranes and screens manufactured by Nucleopore. Alternatively, a plastic diaphragm having precision holes drilled therein with a laser could also be used. When using a hydrophobic membrane, blood may be introduced into the cell-separation chamber, but will not fall into the densification chamber. The proper hydrostatic pressure may be achieved by first separating the red blood cells from the plasma at a low rpm. Subsequently, the rate of centrifugation is increased to achieve the desired pressure to overcome the surface energy/surface tension constraints that define the flow pressure. In other words, the gravitational force will increase with the rate of centrifugation, which will result in the platelet-rich plasma flowing through the membrane, but not the red blood cells. The membrane will substantially block the red blood cells.

Another modification to the above systems includes changing the configuration of the secondary or densification chamber of any of the embodiments discussed herein. These modified densification chambers may be used in systems, wherein the primary and secondary chambers have the same or different radii, wherein the chambers are concentric, and/or wherein a separating medium or hydrophobic membrane is used. The densification chambers may have a different interior walls which facilitate the removal of the membrane, and ensure the greatest recovery of the membrane. For instance, the densification chamber may contain a woven biodegradable fabric (such as Goretex® manufactured by Goretex) that improves the tear strength of the membrane for initial placement in the body, and that will later dissolve. The outer wall of the chamber may also contain molded bumps or grooves that support the fabric away from the wall at a uniform length to achieve a fibrin and platelet thickness of desired dimension on both sides of the fabric.

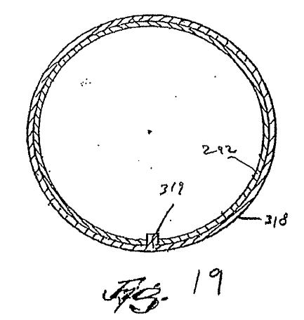

More particularly, as shown in FIG. 19, the interior or side wall of the densification chamber 318 may include one or more solid or serrated ribs 319 to allow removal of the membrane in the form of flat sheets rather than as a cylinder. The perforated ribs facilitate aeration of the membrane. The interior wall of the chamber may be configured to provide perforations in the resulting membrane to facilitate tearing. FIG. 19 shows a bottom plan view of one or more solid ribs of the interior wall.

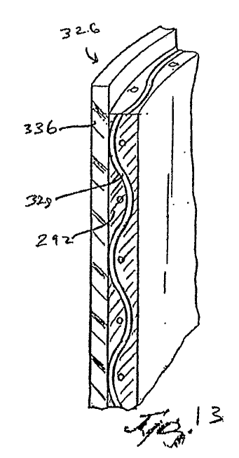

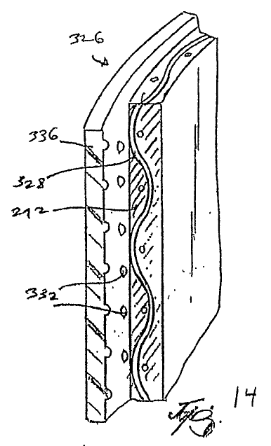

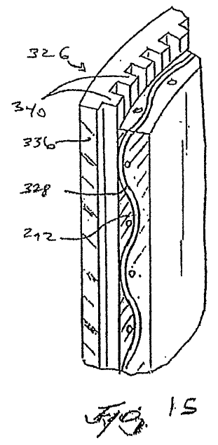

FIG. 13 illustrates a woven-biocompatible fabric 328 that may be found on the interior of a densification chamber 326. Such a weave keeps the membrane 292 away from the wall itself. The fabric 328 facilitates separating the membranes from the cylinder to get a flat membrane and increases the tear strength of the membrane for certain applications. The fabric 328 becomes embedded in the membrane 292. Moreover, bumps 332 or grooves 340 may be molded in the wall 336 of the chamber 326 to control the thickness of the fibrin layer on either side of the fabric as shown in FIG. 14 and FIG. 15, respectively. These act as small-supporting ribs that keep the fabric spaced away from the wall. In summary, FIG. 13 shows the fabric 328 keeping the membrane from sticking to the wall 336; FIG. 14 shows bumps 332 in the wall 336 that facilitate removal of the membrane 324; and FIG. 15 shows grooves or molded support ribs 340 that keep the membrane 292 away from the wall. Walls having bumps 332 or grooves 340 may also be employed independently of the fabric 328.

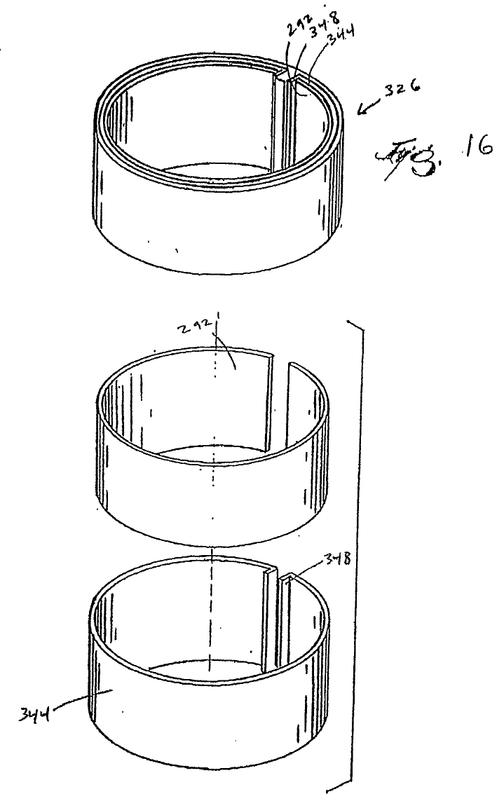

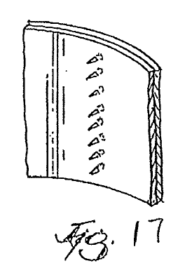

Alternatively, as shown in FIG. 16, the densification chamber may be lined with a removable film 344 to facilitate removal of membrane 292. The film 344 may comprise plastics such as polyolefins which include polyethylenes, polypropylenes, polycarbonates or TEFLON®. The film 344 may have tabs 348 for easy manipulation, and may be colored to help separate the membrane 292 from the film 348. In addition, the film 348 may be treated to obtain desirable properties, such as glass-like contact activation. By maneuvering the tabs 348, the entire film 344 having the membrane 292 thereon may be removed. For example, the densification chamber 326 may be lined with a treated film that provides both platelet activation for coagulation and growth factor release and easy manipulation of the membrane. Alternatively, the PRP or PPP may be flowed through a high surface energy tubule to activate the PRP or PPP for clotting, enabling a rapidly clotting adhesive to be used as a fibrin sealing or adhesive layer.

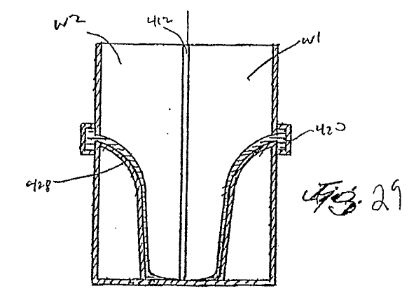

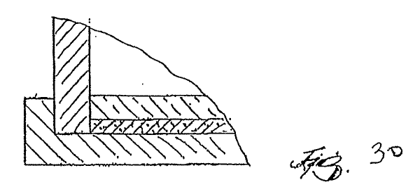

Regarding other surfaces in the chambers, plastic surfaces may work, but may not be ideal for clot activation and release of platelet growth factors. As a result, alternatives to plastics are outlined in FIGS. 30 and 31. For example, the platelet-rich plasma may contact glass in the lower chamber. In other words, glass could be affixed to the bottom cap as shown in FIG. 30, or glass spheres may be glued or hot staked to the bottom as shown in FIG. 31. Glass could also be heated and dropped onto the plastic. Alternatively, the surface may be plasma treated using glow discharge processes employing activating gases such as oxygen or nitrous oxide. More particularly, the surface could be treated using plasma enhanced chemical vapor deposition. Alternatively, the surface may be modified using a variety of chemical coatings, e.g., silicon surfactants or PVPyr. Another manner by which to modify plastic is to put small sized silica beads or particles in the citrate solution in the upper chamber. Due to the high density of silica relative to the gel and red blood cells, most of the silica will remain in the upper chamber either below the gel or embedded in it. Accordingly, these plastic modifications may be used to coat portions of the systems, and more particularly, portions of the densification chambers of any of the embodiments set forth herein.

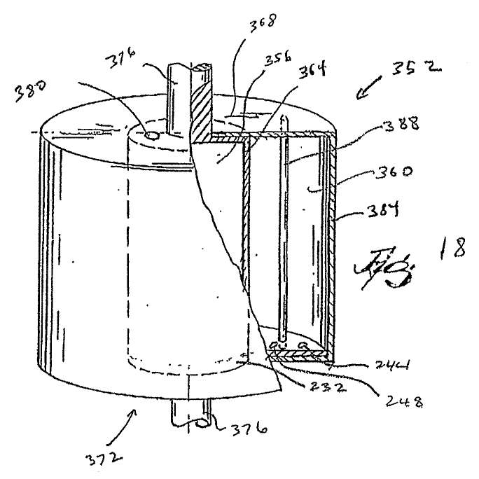

Another aspect of the invention provides for the production of square-shaped platelet-rich fibrin membranes to be used in conjunction with wound care, which exploits the mitogenic characteristics of platelet and provides platelet-derived growth factors (PDGF) and beta-thromboglobulin (BTG), and protective action of a solid-fibrin film. Growth factors, BTG, platelet factor 4 (PT4) and thrombospondin are all factors that may enhance cell proliferation on the solid-fibrin web. More particularly, protective action includes microaerophilic environment, anti-septic activity, and separation activity. The device, which can be used to carry out concurrent centrifugation and coagulation, comprises a rotor medical device shown in FIG. 18. The device comprises a disposable cartridge 352, which may be made of plastic or some other suitable material. Again, the plastic modification techniques discussed above apply to any of the embodiments set forth herein. The cylindrical cartridge has two concentric chambers, namely, an inner chamber 356 and an outer chamber 360.

The inner chamber 356 is cylindrical and defined by an inner filtering wall 364 as shown in FIGS. 18 and 19. Any of the filters or filtering devices discussed herein are suitable for use with this embodiment. The inner chamber 356 has a top end 368 and a bottom end 372, each of which has a rotor shaft 376 attached thereto. The rotor shaft 376 allows the cartridge 352 to be inserted and used in a centrifuge (not shown). At least one of these ends 368, 372 of the inner chamber 356 may have a port or suitable aperture 380 through which blood from a patient may be introduced or injected. As discussed above, in one embodiment the inner chamber 356 may be kept at a vacuum in order to facilitate standard venipuncture. The inner chamber 356 may contain an anticoagulant 232 to prevent blood entering therein from coagulating. The inner chamber 356 acts as the cell-separation chamber. The inner filtering wall 364 is a selectively centrifugeable (mechanically supported) filter, which will accept a discrete amount of whole blood. The filtering activity of the filtering wall substantially prevents red and white blood cells from flowing therethrough. The filter does, however, allow plasma and platelets to flow through to the second chamber 360 when a predetermined centrifugal force, e.g., greater than 1000×g for a predetermined time, e.g., greater than 10 minutes is exerted.

The second chamber 360 is defined by an external wall 384, the internal filtering wall 364 as well as top and bottom walls. The second external chamber 384 may include one or more coagulation activators 244 as well as one or more secondary active agents 248 discussed above. The second chamber 360 acts as the densification chamber. As shown in FIGS. 18 and 19, the internal and external chambers 356, 360 are concentric.

In operation, after blood has been introduced into the inner chamber 356, the device 352 is centrifuged. As discussed above, the centrifugation takes place at a predetermined force for a predetermined time such that the blood is separated into plasma and red blood cells. Again, the filtering wall 364 allows the platelet-rich plasma to pass therethrough, whereas the red blood cells clog the filter. Upon passing through the filter 364, the plasma contacts the coagulation activator 244 and/or secondary active agent 248, thereby resulting in concurrent coagulation and centrifugation, and the formation of the membrane. To enhance coagulation, it may be helpful to provide a mixing movement. The centrifugation takes place after the plasma has entered the second chamber and usually occurs at about 1500 to 15,000×g for greater than 10 minutes in order to obtain a white resistant fibrin-platelet rich membrane. The membrane can be used in any of the tissue regeneration applications set forth herein, but may be particularly useful in conjunction with wound or burn care.

On the inner portion of the external chamber 360, one or more pins 388 may be present to enable the membrane to be drawn out vertically from the top of the device. All of the discussion pertaining to the surface of the densification chamber, applies here to the outer chamber 360 (e.g. using fabrics, bumps, grooves, etc.). In addition, the discussion pertaining to modification of plastic surfaces also applies here as well. The membrane may be extracted by crunching the device, or opening it in two parts. Typically, for sanitary reasons, the device is disposable. The device provides friendly operations and provides safe and sterile conditions.

Another aspect of the invention pertains to devices and methods, as well as modifications of the above devices and methods, which can be used to form molded, high-density fibrin and platelet networks by radial or axial centrifugation. This aspect also pertains to a method for metered liquid splitting into multiple aliquots for simultaneous molding of multiple networks. The clinical efficacy and ease-of-use of autologous fibrin and platelet networks are discussed above. There are several clinical applications for the regeneration of soft tissue (e.g., meniscus repair of the knee), in which it is desirable to form the network or membranes discussed above into a specific shape prior to implant. In the case of meniscus cartilage, the ideal shape would be a semi-circular wedge shape, similar to an orange section, which can be used to replace a severely damaged meniscus. The platelets present would provide needed vascularization for tissue regeneration and the fibrin would provide an absorbable cushion for load bearing.

Current practices for repairing soft tissue, such as cartilage, allow for only twenty percent of cases to be treated. Frequently in the remainder of the cases, the soft tissue is permanently removed and the patient suffers from compromised mobility. This syndrome is evident in professional athletes and is of great interest in sports medicine. Synthetic materials are available to form as a scaffold for new tissue to grow into, but have the disadvantages of causing adverse immune response and poor success due to lack of vascularization. A successful method would enable splitting the platelet-rich plasma into controlled volumes for simultaneously forming multiple forms and shapes used for a given procedure.

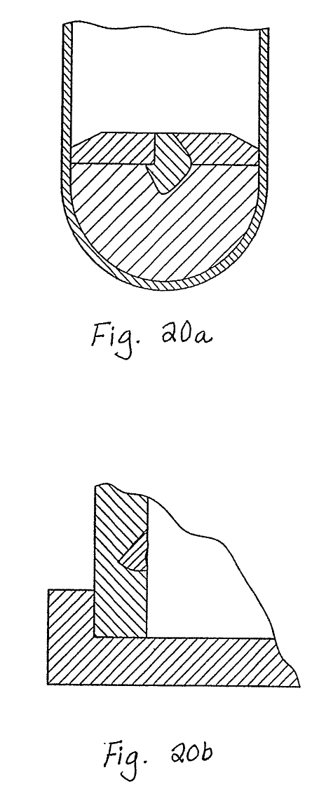

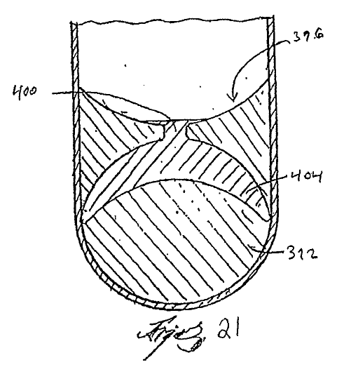

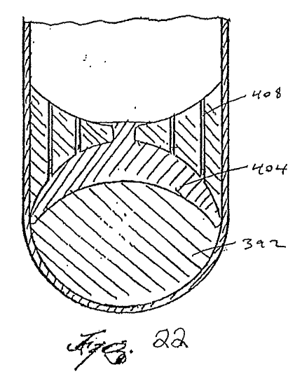

The mold system comprises a formed cavity defined by a shape of a desired part at the maximum point of centrifugal force in any of the centrifugation containers discussed above. The cavity may be formed at the bottom of a vessel when the centrifugation is performed in a radial centrifuge. Alternatively, the cavity may be defined in the cylindrical wall of vessel that is axially centrifuged. FIG. 20 shows examples of a mold oriented for use in a radial centrifugation as shown in FIG. 20(a) and a mold oriented for use in an axial centrifugation as shown in FIG. 20(b). The mold may be integral to the container or may be a separate part connected, coupled, extended or added to the vessel as shown in FIGS. 23-26. The cavity, if non-integral, may be of split design to allow molding of complex shapes and to provide for easy removal. The cavity may also contain a funneling feature to direct the flow of the fibrin/platelet mixture into the cavity as shown in FIG. 21. More particularly, FIG. 21 shows a mold 392 having a funnel 396 leading to a runner 400 which allows a substance to flow information to the cavity 404. The cross-sectional area of the funnel opening 396 will determine the relative amount of concentration of the fibrin/platelet monofilaments. A runner 400 may also be connected to the funnel 396 and cavity 404 as shown in FIG. 21, thereby allowing flow directly into the cavity 404 and minimizing any trimming of the molded part. As shown in FIG. 22, vent holes or passageways 408 may also be included into the mold frame 392 to allow the expression of gas and/or liquid out of the cavity 404 caused by the displacement of the entering fibrin. In other words, the vent holes 408 allow for the release of gases and liquids.

In procedures requiring multiple implants, particularly ones requiring different volume and density, one of the axial-centrifugation devices discussed above may be split into controlled volumes by inclusion of vertical vanes in the bottom as shown in FIGS. 23-27. In other words, one of the devices discussed above, e.g., a concentric chamber embodiment may be employed, but multiple cavities are used in each centrifuge vessel to simultaneously provide multiple-shaped objects. The relative amounts of platelet-rich plasma to be sent to each mold in the axial-spin design can be obtained by including vertical vanes 412 as depicted in FIGS. 23-27. The vanes 412 may extend the height of the device although they need not, and project toward the central axis but do not touch, thereby allowing free flow of the platelet-rich plasma between the volumes defined by the vanes.

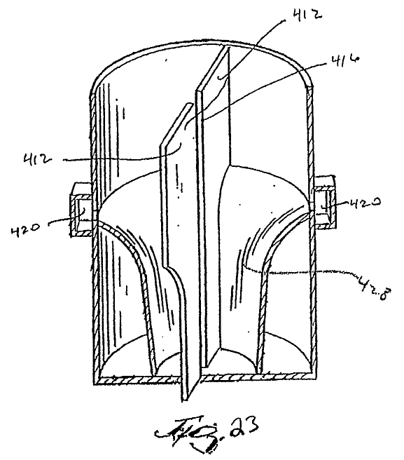

FIG. 24 is a top plan view showing vanes B1 and B2. Vanes B1 and B2 do not touch, and vent 416 allows fluid connection between chambers W1 and W2 when the fluid is first added and the centrifuge is at rest. The cross-sectional area of chambers W1 and W2 may be proportional to the volume of the fluid to be sent to each mold. The liquid level, initially at rest, is equal in all compartments, thus the relative volumes are proportional to the cross-sectional area defined by the positioning of the vanes. Accordingly, the positioning of the vanes will determine the volume in each compartment. Consequently, larger “pie pieces” can be employed for deeper molds.

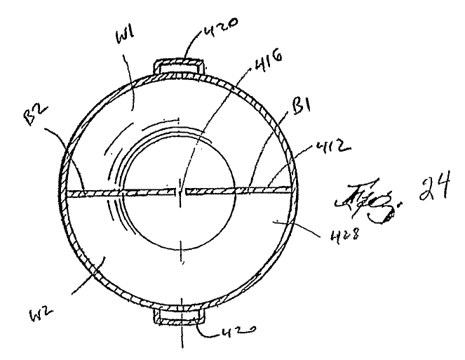

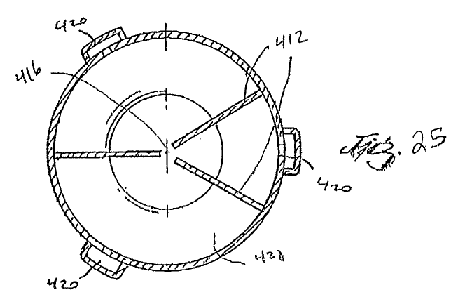

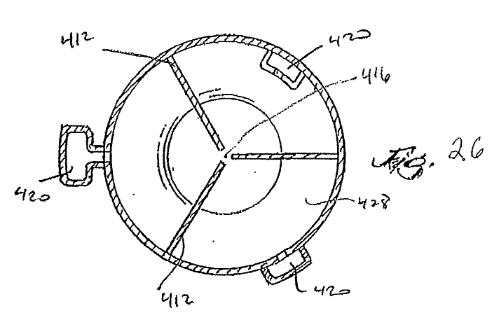

Once centrifuged, the volume in each compartment travels radially to the target mold. FIG. 25 depicts a three-chamber device having unequal “pie pieces.” FIG. 27 shows a three-chamber device with each mold 420 set at a different radius, thereby subjecting the contents of each mold 420 to g force proportional to the radius. The number of chambers will depend on the particular application. The formed materials will have different densities depending on the radius of the mold 420. FIG. 26 shows molds in three different positions, namely, integral, connected and extending from the device. The positioning of the mold affects the density of the resulting membrane. Since the relative volume of each aliquot and the location of the cavities are predetermined, molded counterweights can be added to provide proper balance. An example of a useful application of this feature would be the molding of a membrane at high density and a paste at low density.

In operation, platelet-rich plasma is added to a vessel, such as those discussed above, or is prepared by adding whole blood to a pre-processing chamber and transferring the platelet-rich plasma to a second vessel containing a suitable clot activator. The vessel is quickly placed in the centrifuge and spun at the desired g-force required for the application. This provides for the concurrent centrifugation and coagulation. The fibrin strand and platelets rapidly sediment toward the cavity and fill it. The fibrin strands are then cross-linked to form a stable network. Upon removal from the centrifuge, the molded part may be removed and any excess trimmed. For more complex shapes, a split cavity mold may be employed. As discussed above and shown in FIG. 21, a funneling pre-processor may be employed in the design to minimize blood volume required and to increase efficiency. Runners and vent holes as shown in FIGS. 21-22 may also be included to ensure the complete filling of the cavity and to facilitate handling of complex shapes, much like the runner system that is employed in plastic model kits for hobbyists.

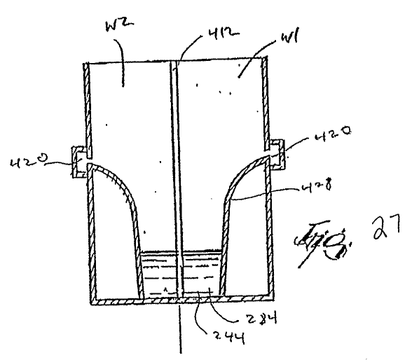

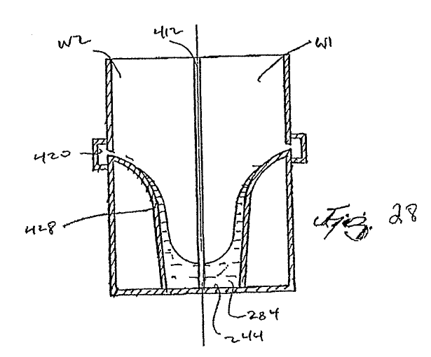

FIGS. 27-29 show cross-sectional views of the device during operation. FIG. 27 shows the device at rest; the platelet-rich plasma 284 and coagulation activator 244 mix flows between chambers until a level fluid surface is achieved and the fluid is properly proportioned between chambers. FIG. 28 shows the device as the centrifuge starts; the liquid is formed into a vortex shape by the axial rotation. During centrifugation, the vanes 412 now prevent communication between channels and thereby maintain the proper dispensing to each mold. The walls 428 may be tapered towards the mold to act as concentrating funnels. As the centrifuge speed and resulting g-force increase, the parabolic vortex increases until all fluid is transferred to the molds. FIG. 29 shows the device at full centrifugation, at which point the molds are filled.

This system may also be used for platelet-poor plasma (PPP) to form substances comprising fibrin. In other words, it may be used in applications that require no platelets. Platelet-poor plasma may be formed by centrifuging a first tube at a higher g force, e.g. greater than 5,000×g, instead of 1,000×g. Also, the design can be used for non-autologous formation of the desired fibrin or fibrin/platelet network in cases where suitability of donor and recipient is established.

Overall, the molds provide complete and autologous patient compatibility. As a result, the fibrin-platelet network can be formed to precise molded shapes and densities. A multiplicity of shapes can be formed simultaneously, such as the left and right meniscus for the knee. In addition, a molding hammer, anvil and stirrup for an inner ear may be found using these molds, as well as a rotator cuff for a shoulder. Furthermore, elbow cartilage, parts of etepicondyle, parts of fingers, tarsus and carpus cartilage may also be formed. The formed membrane or network is also absorbable, stable and has growth factors to improve healing. For multiple shape applications, density of the parts can vary by setting the mold radius.

Another aspect of the invention pertains to devices and methods for controlling the distribution of platelets in a fibrin/platelet network utilizing differential centrifugal sedimentation. The clinical efficacy and ease-of-use of autologous fibrin and platelet networks are discussed above. The fibrin provides wound stasis and a medium for cell growth and mobility. Platelets, while initially contributing to wound stasis, also contain a variety of anti-inflammatory, growth and vascularization agents. As such, in many therapeutic procedures it is beneficial to concentrate the location of the platelets in the fibrin continuum. For example, in the case of chronic wounds, a concentration of platelets on the side of a membrane that contacts the wound would increase adhesion of the membrane to the wound and increase vascularization of the sub-dermal layer. For meniscus repair, it may be beneficial to have the platelets concentrated in the outermost region of the formed meniscus, namely, the “red zone,” to increase vascularization of this region. For bone cement, it may be preferable that the platelets are evenly distributed throughout the continuum. Consequently, this aspect of the invention provides a manner by which to preferentially locate platelets in a fibrin matrix using centrifugal force.

Platelets sediment as a function of g-force while the formation of fibrin proceeds at a rate independent of g-force. More particularly, platelets sediment at constant velocity, and as a result, the platelets deposit at a constant rate until all have sedimented. Platelets are uniformly distributed throughout the platelet-rich plasma. As the plasma is subjected to a gravitational force, the platelets sediment at a constant velocity, the velocity increasing with increasing gravitational force. The time to complete the sedimentation is proportional to the height of the platelet-rich plasma that the uppermost platelets must traverse. Thus, for a 100 mm high column of platelets, the completion time for sedimentation is approximately 5 minutes at 6000×g or 15 minutes at 2000×g.

Fibrin monomers, on the other hand, form at a rate independent of gravitational force. For normal patients, this process is complete in about thirty minutes. Thus, the methods set forth herein solve the problem of developing a centrifugal force profile that will accommodate the two different rates of sedimentation, thereby resulting in preferential location of the platelets within the network. Preferential location of the platelets optimizes the tissue regeneration to fit each particular application, providing faster healing and higher success rates for the procedure. The method to preferentially locate the platelets involves adjusting the g-force during the sedimentation process to account for the difference in sedimentation rates of the platelets and the formation and subsequent sedimentation of the fibrin.

In one example, the platelet-rich plasma may be exposed to the coagulation activator, and then immediately centrifuged at about 4000 to 6000×g. Accordingly, the platelets will rapidly sediment in about 5 to 10 minutes and will then be layered on top with the fibrin that forms over the subsequent 25-35 minutes. The resulting structure will have the platelets concentrated on the surface that was initially formed and will diminish in the layers formed later. This application is particularly advantageous for meniscus repair and chronic wounds.

In another example, the platelet-rich plasma may be exposed to the coagulation activator, and then immediately centrifuged at greater than 2000×g. The platelet sedimentation and the fibrin formation may proceed at equivalent rates. Accordingly, the resulting network has platelets uniformly distributed throughout the network. This application is particularly advantageous for bone cement and for soft tissue growth in periodentistry.

In yet another example, the platelet-rich plasma may be exposed to the coagulation activator and immediately centrifuged. The speed of centrifugation, however, is cycled between alternative rates of about 1-2 minutes at about 4000-6000×g, then about 5-10 minutes at 1000-2000×g. The iteration may be performed about 5-10, resulting in a sandwich structure that has 10-20 distinct layers of alternating high concentration and low concentration platelets. This application is particularly advantageous for articulate cartilage repair, which prevents bones from rubbing together.

Consequently, controlling the rate at which the platelet-rich plasma and coagulation activator are centrifuged, as well as duration of the centrifugation, results in preferential location of the platelets. Controlling the location of the platelets optimizes the tissue regeneration depending upon the particular application, thereby providing faster healing and higher success rates of the procedure.

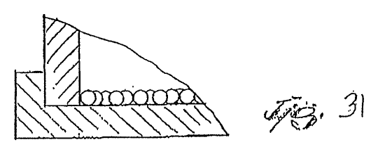

FIG. 32 shows another embodiment of the mold design. The molded insert 424 is generally made of a plastic or rubber material. The insert is introduced into and removable from a container 426 as shown in FIG. 32. Once platelet-rich plasma is situated in a container 426, a coagulation activator may be added thereto. Alternatively, a coagulation activator may be already be present in the plasma upon introduction. The insert has vanes 432 similar to those in FIGS. 22-29. The vanes 432 protrude in order to define chambers 430 in which a membrane may be molded or formed upon centrifugation. In other words, the vanes leave a space between a core 434 of the insert and the container when inserted, in which a cylindrical membrane may be formed using a radial centrifuge. Although the insert is shown with three vanes, the insert may be fabricated having one or more vanes. Alternatively, the insert could be split so that a rectangular membrane is formed between the two inserts. The advantage to using the molded insert 424 is that a flat bottom vessel with a swing head centrifuge is not required.

In another embodiment, the invention provides methods and devices used to treat people suffering from cartilage diseases. Fibrous cartilage tissue has a complex structure made in multi-layer organization of chondrocytes encapsulated in an amorphous fibrous tissue, the main component of which is collagen, plus ialuronic acid, and polysaccharides. The inner layer is the most compact one (i.e. it may be up to 25 times stiffer than outer layers), while the other two softer layers are recognized towards the surface. Pathological cases involving the articular cartilage tissue are common in humans and in animals, due to infections, auto-immune diseases (like arthritis), age-related degeneration and traumatic events. Today's cares are focused on pharmacological treatment of patients to stop infections, to reduce inflammation, or to stimulate the natural regeneration of autologous cartilage tissue. In painful cases, like treatment of knee meniscus breakage, surgical treatment is performed to eliminate the cartilage that is not replaced, leaving the patient's bone without protection. This embodiment provides methods to treat cartilage diseases.

The membranes and fibrin may be used as scaffolds to culture chondrocytes. More particularly, these methods could be applied to humans and to animal cells to produce biological active hard solid fibrin cushions, with autologous chondrocytes included, to replace damaged cartilages in vivo to support the mechanical stress and to start the biological recovery of the tissue. In one particular embodiment, starting from a biopsy of cartilage tissue that is digested enzymatically, as known by the ones skilled in the art, the chondrocytes are cultivated in monolayers with conventional protocol in a CO₂ incubator. The chondrocytes, once carefully detached from their supports, can be mixed with the PRP just before spinning the container at about 4,000 to 10,000×g in order to obtain “orientated” strong membrane that can be used to replace part of damaged cartilage in vivo. The centrifugal force applied may differentiate the chondrocytes in different kind of cartilage.

The fibrin scaffolds having the chondrocytes can be cultured for several days in a special bioreactor under sterile conditions (as described by R. Portner, Animal Cell Culture Group—Dortmund University). In this device the DMEM (Invitrogen) culture media, added with serum, TGF (Transforming Growth Factor—Cell Concept) IGF (Insulin like Growth Factor—Cell Concept) is continuously refreshed on to the scaffold in a flow chamber. This procedure may be conducted for 19 days. The scope is to produce real cartilage in vitro on the base and shape of the original fibrin. This new cartilage may be used to replace damaged cartilages in vitro.

In one method, a very strong autologous membrane may be formed using concurrent coagulation and centrifugation methods discussed above. More particularly, a thick membrane (e.g. a 3-mm thick and 24-mm in diameter) may be prepared according to Example 5 below. Of course, a wide variety of sizes of membranes may be made using any of the devices or methods discussed above. One particular membrane may be made in a sterile container (e.g., a flat bottom 25 ml glass flask filled with about 20 ml of autologous platelet-rich plasma (PRP) and spun at about 4500-5000×g for 30 minutes). In this step platelet poor plasma (PPP) could be used. Any of the other membrane formation techniques set forth above may also be employed.

After this, or any other membrane of the invention, has been formed, it may be thoroughly washed with sterile physiological solution and placed in a larger sterile flask containing the activator, to prepare a second layer of platelet-rich fibrin (PRF). In this step, a new amount of platelet-rich plasma is introduced, in complete sterility, in the new flask containing the strong membrane. A second flask may be submitted to a second centrifugation step in order to obtain a triple layer membrane. In one particular example, this centrifugation may take place at a rate of 1000×g for 20 minutes to form a 30 mm in diameter. Centrifugation may take place at any of the rates set forth above (namely, 500 to 15,000×g for greater than 10 minutes.) The resulting membrane could be used to implant where the cartilage is to be replaced. Again, the thickness and dimensions of the membrane are dictated by the conditions set forth above. The amount of blood and the type of flask will also change accordingly. The key is to expose a sterile membrane (formed by any of the processes set forth above) to additional coagulation activator, and subsequently centrifuge the contents in order to form a second layer of platelet-rich fibrin. Alternatively, an additional coagulation and centrifugation could form a third layer of membrane, and so on.

In a related method, cartilage tissue (autologous) is put in culture IN VITRO in a gel, according to the Alginate Recovered Chondrocyte (ARC) method, which is well-known to those having skill in the art. The gel in the ARC method could be replaced by autologous fibrin prepared according to the methods and devices set forth above. More specifically, during the second step of the preparation of platelet-rich fibrin, the selected chondrocytes strains can be added to the secondary container together with autologous fibrin and the mix could be brought to jellify at a low centrifugation rate, or with no centrifugal force applied at all.

The form and dimensions of the container in which the jellification takes place may be chosen according to the subsequent use of the “artificial cartilage” (i.e., the form of the cartilage to be replaced). The jellification may be performed in such a way that the gel is formed around the strong membrane prepared according to the preceding paragraph. This may be achieved by placing the strong membrane inside the container where the second clotting is taking place, in such a way that new gel will substantially surround the original strong membrane and the chondrocytes will be included in the gel. The sterile container having autologous chondrocytes, jellified autologous platelet-rich fibrin, and eventually the inner strong membrane, may be put to incubate in an appropriate atmosphere (temperature, O2, CO2 and R.H. levels), as it is known to people having skill in growing chondrocytes in vitro. This may give the new tissue grown in vitro on a fibrin gel scaffold. Once the tissue culture has the correct density of chondrocytes and fibrous tissue, a triple layered tissue will result in a membrane that is very strong inside and soft and ready to replace the sick tissue in the host. Appropriate additives will be added to the culture media in order to optimize the yield of the procedure. The use of stem cells can also be previewed, since these are the origin of all cells in the body, they can originate new chondrocytes in vitro, if properly treated as is known to skilled people.

Overall, this embodiment produces an implant to treat the above-described illnesses, while reducing the risks connected with use of synthetic or heterologous materials. The autologous chondrocytes will find in the membrane, enriched with platelet, the proper solid scaffold for proliferation in vitro and in vivo and to produce the chondrocyte matrix that is fundamental for the production of new cartilage. The resulting membrane is easy to prepare in a sterile cabinet and has the physical properties that allow it to be implanted directly in place in order to reduce the recovery time after surgery, and to facilitate the migration of chondrocytes that will build up new cartilage.

The embodiments and methods described herein may also be used in conjunction with collection of PRP from a plasmaphoresis machine. Many times during surgery a cell saver or phoresis machine is used to conserve blood by suctioning the pooled blood in a surgical site, separating the cells and reinfusing the cells into the patient. This technique, sometimes called “bloodless surgery,” minimizes or eliminates the need for blood transfusions to replace lost blood, making the procedure safer and less expensive. Such equipment is made by Haemonetics (Braintree, Mass.) and Cobe (Colorado). These phoresis machines sometimes are used to separate platelets and plasma from the red cells. Access to the platelet and plasma port of these machines allows collection of PRP. If the PRP is added to the second tube, it is recalcified and can be simultaneously centrifuged and coagulated, in conjunction with the methods set forth above. This enables larger volumes of PRP to be obtained, while eliminating the first centrifugation step and collection device. A wide variety of solid-fibrin webs and membranes may be obtained therefrom, and used in the application herein.

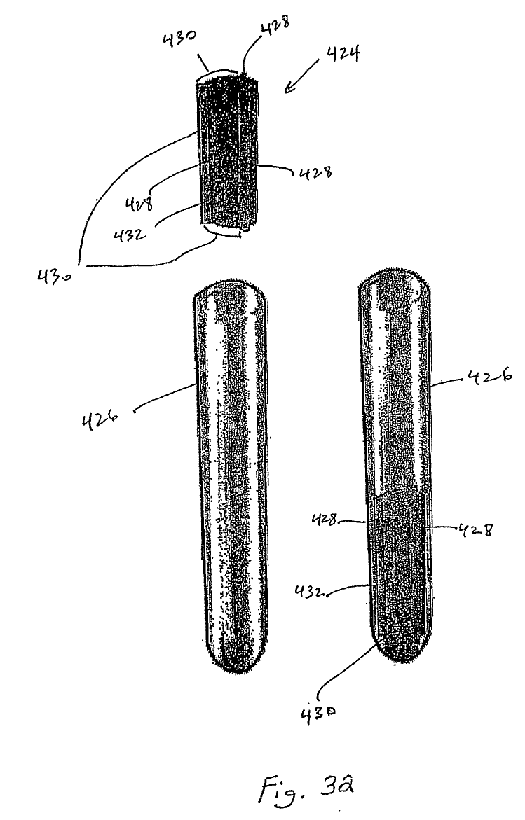

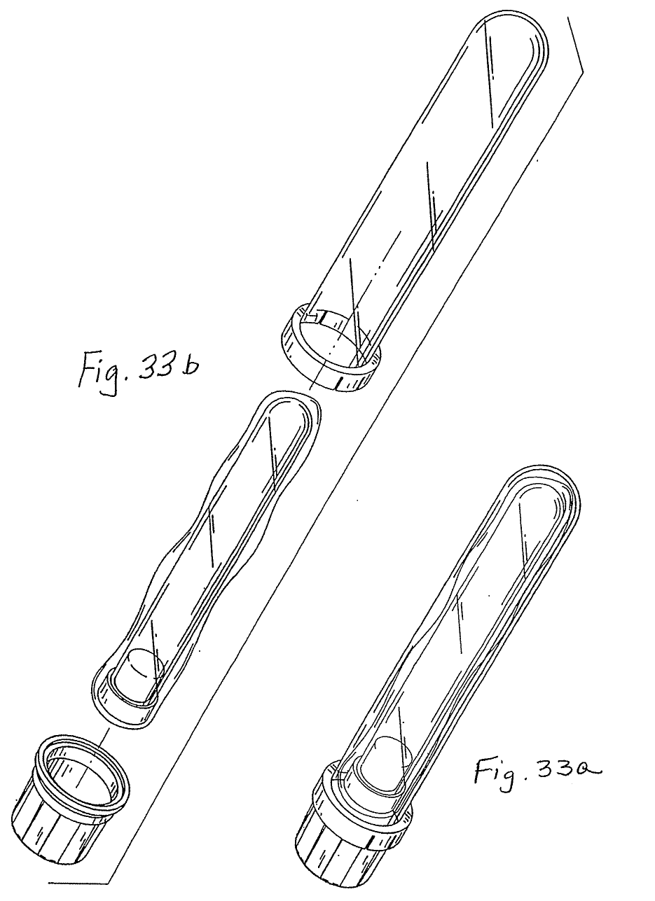

The majority of centrifuges are designed to process a blood collection or second fibrin/platelet network tube having dimensions of about 16 mm×125 mm. Tubes of these dimensions tend to hold a maximum capacity of 15 mls. These tubes are nested in a centrifuge cup that is removable for cleaning purposes. The cups are tube-shaped and may have a collar to support the tube and cup during high-speed centrifugation (FIG. 33). Metal forming or injection molding of polymeric materials can integrally form the collar onto the tube. It can also be separately formed and adhered to the tube by adhesive, ultrasonic welding, spin welding, induction welding or other methods of material adhesion; these methods do not require the collar and tube materials to be the same, allowing greater choices of material selection. Alternatively, the tube may have a tapered outer diameter that narrows towards the lower, closed end and the collar may have a mating inverse taper in its inner diameter, such that the tube, when inserted into the collar, can only proceed to the point where the tube outer diameter and the collar inner diameter interfere, the distance from the tube's open end being preset during the forming operation. The collar should have an inner diameter that allows sufficient contact with the tube to support the tube during the high shear forces developed at centrifugation. The thickness of the collar, i.e. the height of the squat cylinder, is determined by the material properties of the collar and the forces the collar will be subjected to during centrifugation. The outer diameter of the collar should be sufficient to preclude the tube movement radially outward during centrifugation. The dimensions of the collar may be easily calculated using engineering computation or computerized finite element analysis.

The materials of construction are typically steel or engineering plastics of high strength. In many applications of fibrin and platelet networks, such as spinal fusion and plastic surgery, larger volumes of PRP and/or fibrin platelet networks than those obtainable with 16×125 mm tubes are desired. A method for obtaining significantly larger volumes of blood collected or fibrin/platelet comprises making the collecting or receiving tube larger by affixing a support collar thereto or integrally forming the collar thereon. The tube can be placed directly into the centrifuge rotor after removing the supporting cup. The material of construction of the tube may hold vacuum, accept a stopper, be compatible with blood and have sufficient strength to withstand centrifugation. Examples of suitable materials include, but are not limited to, metal, glass with a support collar attached by an adhesive, or a high strength barrier plastic such as polyethylene terapthalate (PET) or polyethylene napthalate (PEN). Such a tube may have a diameter of about 20 to 30 mm (e.g. 25 mm) and a length of 110 to 140 mm (e.g. 125 mm) and hold more than 20-30 mls. Larger tubes can be made by modifying the rotor to accept larger diameter tubes. This is also useful in diagnostic testing and other procedures in which larger specimen volumes than those obtainable with standard size tubes are desirable.

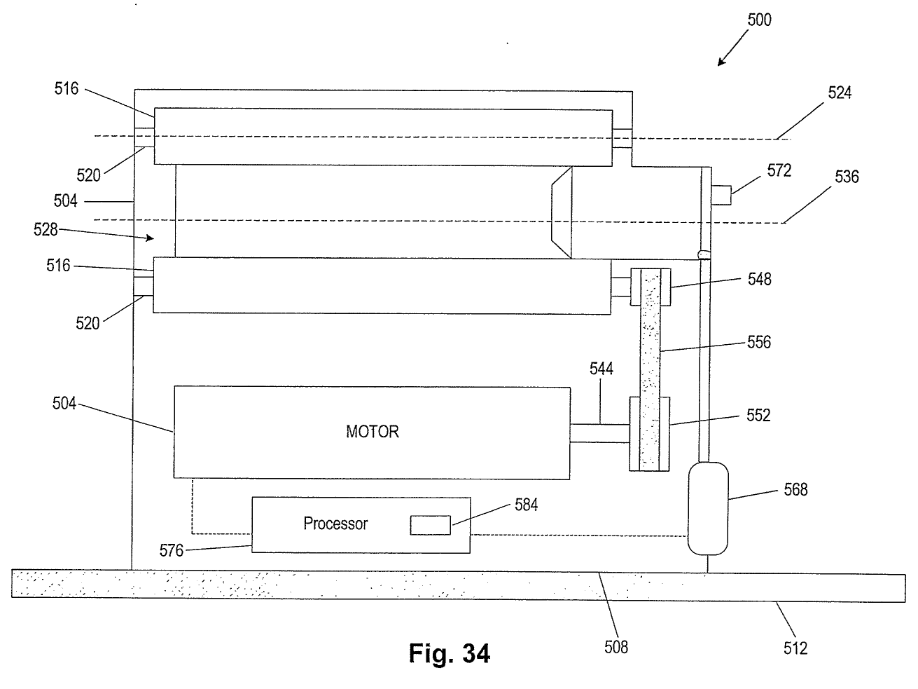

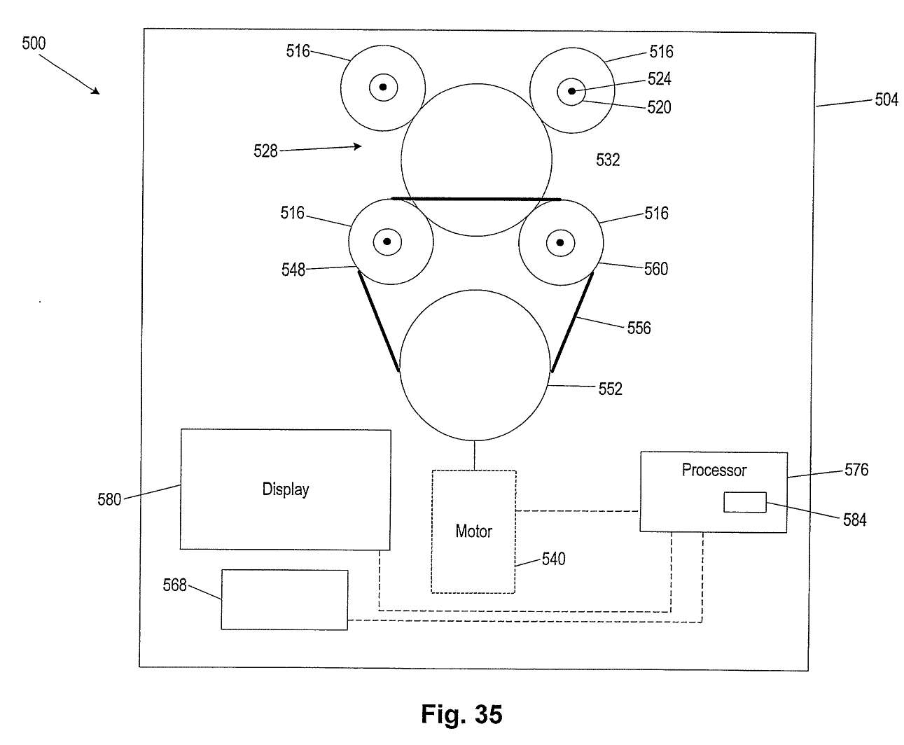

FIGS. 34-35 illustrate a centrifuge 500 according to one embodiment of the present invention. The centrifuge 500 includes a housing 504 having a base 508. The base 508 is supportable on a substantially horizontal surface 512 and is at least partially arranged to be substantially parallel with respect to the surface 512. The centrifuge 500 also includes a plurality of rollers 516, each roller 516 having a shaft 520 and being supported by the housing 504. Each of the rollers 516 is adapted to rotate about its respective shaft 524. Each shaft 520 includes an axis 524 oriented to be substantially parallel with respect to one another and with respect to the base 508. In other words, each axis 524 is also substantially oriented to be arranged in a substantially horizontal plane.

In the construction illustrated in FIGS. 34-35, the centrifuge 500 includes four, rollers 516. The drawings can be described as having two upper rollers 516 and two lower rollers 516, but it is noted that the use of upper and lower is relative to the drawings (as normally viewed) for convenience. These directions are not intended to be taken literally or limit the present invention in any form. The arrangement of the rollers 516 at least partially define a chamber 528 adapted to receive a container 532. The container 532 can vary in length and diameter. The container 532 includes an axis 536, and when positioned in the chamber 528, the container 532 is oriented in a substantially horizontal plane and the axis 536 is oriented to be substantially parallel with respect to at least one of the roller axes 516 and/or the base 508.

The centrifuge 500 also includes an actuator 540, such as a motor supported by the housing 504. The actuator 540 includes a rotor or a shaft 544 operable to provide a rotational output from about 1,000 to about 25,000 rpm. The centrifuge 500 also includes a first wheel 548 coupled to one of the roller shafts 520 and a second wheel 552 coupled to the actuator shaft 544. The first and/or second wheel 548, 552 can be in the form of a pulley. The centrifuge 500 also includes a band 556, such as an elastic member, a cord, a rope, or a chain, that is woven around the first wheel 548 and the second wheel 552. In operation, the actuator 540 rotates the shaft 544 and the second wheel 552 to initiate movement of the band 556. Movement of the band 556 causes the first wheel 548 to rotate, which rotates the roller shaft 520 coupled to the first wheel 548 and the respective roller 516. As the roller 516 rotates, the container 532 also rotates as well as the other rollers 516.

In the construction illustrated in FIGS. 34-35, the centrifuge 500 includes a third wheel 560 coupled to the shaft 520 of a second roller 516. The band 556 is woven around the first wheel 548, the second wheel 552, and the third wheel 560. In operation, the actuator 540 rotates the shaft 544 and the second wheel 552 to initiate movement of the band 556. Movement of the band 556 causes the first wheel 548 and the third wheel 560 to rotate, which rotates the two lower roller shafts 520 coupled to the first wheel 548 and the third wheel 560 and their respective rollers 516. As the two lower rollers 516 rotate, the container 532 also rotates as well as the two upper rollers 516. It is noted that additional wheels can be coupled to the two upper rollers 516 can includes wheels such that the actuator 540 drives all of the rollers 516. It is also noted that the first wheel 548 and the third wheel 560 can be coupled to the shafts 520 of the two upper rollers 516 in place of the two lower rollers 516, such that the two upper rollers 516 are driven instead of the two lower rollers 516 being driven as illustrated in FIGS. 34-35.

The centrifuge 500 also includes an activator 568, such as a push button, to initiate the actuator 540. The centrifuge 500 also includes a door 568 having a handle 572 adapted to open the door 568 and provide access to the chamber 528.

The centrifuge 500 can also include a processor 576 or computer and a display 580. The processor 576 is operable to communicate with the actuator 540 and the display 580 and to receive input from the activator 568. The processor 576 can include a software program 584 operable to provide information to the display 580 for display to the user and to provide instructions to the actuator 540. For example, when the user opens the door 568 of the centrifuge 500, the software program 584 can recognize that the door 568 has been opened and begin a routine of providing operating instructions to the user. For example, the software program 584 can provide instructions to the display 580 to position the container 532 in the chamber 528, to close the door 568, to activate centrifuge process by pressing “start” button 564, and remove container 532 when the centrifuge process is complete. The software program 584 can also generate and provide more or fewer instructions to the display 580 than discussed above.

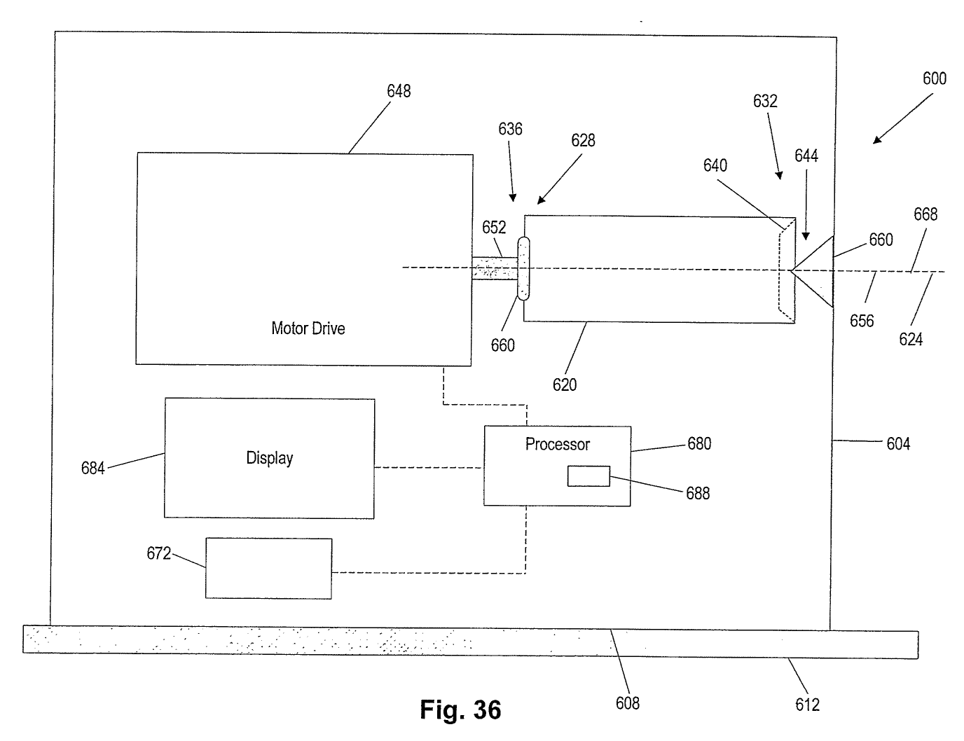

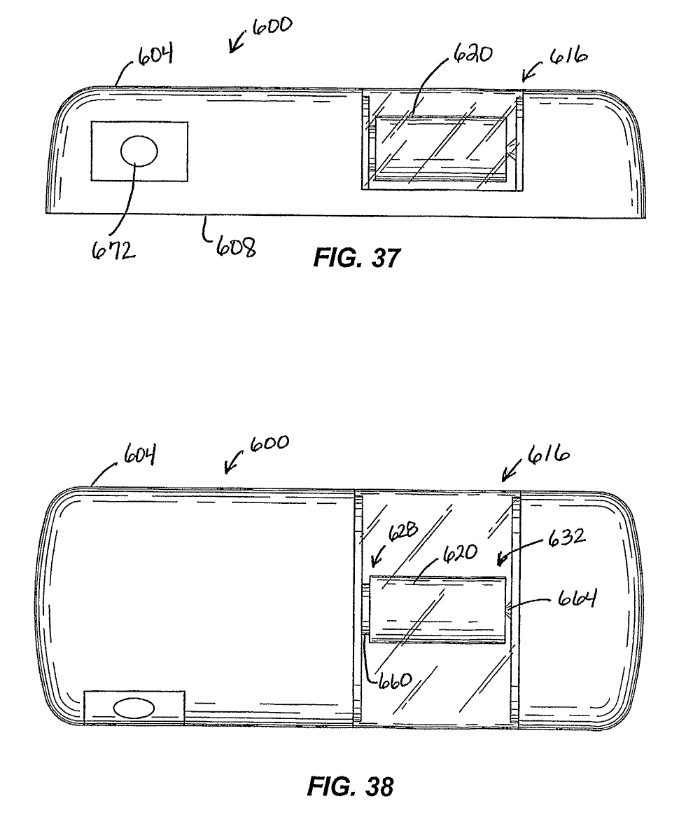

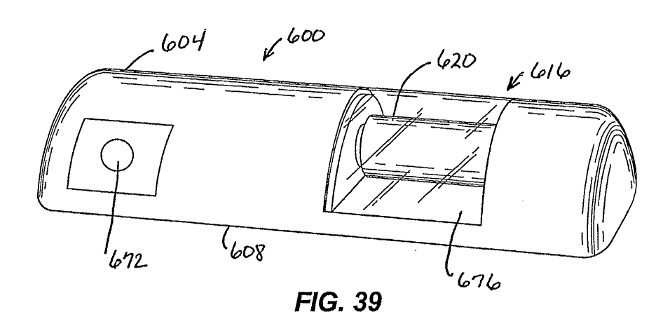

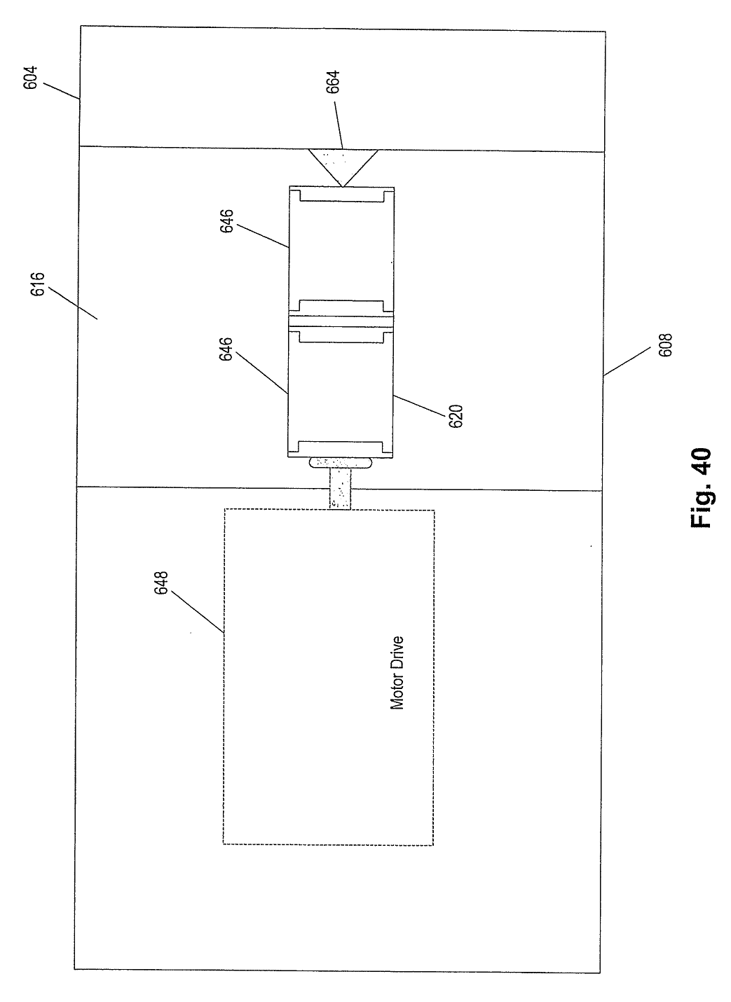

FIGS. 36-40 illustrate a centrifuge 600 according to another embodiment of the present invention. The centrifuge 600 includes a housing 604 having a base 608. The base 608 is supportable on a substantially horizontal surface 612 and is at least partially arranged to be substantially parallel with respect to the surface 612. The housing 604 also includes a recessed area 616 adapted to receive a container 620. The container 620 can vary in length and diameter. The container 620 includes an axis 624, and when positioned in the recessed area 616, the container 620 is oriented in a substantially horizontal plane and the axis 624 is oriented to be substantially parallel with respect to the base 608. The container 620 includes a first end 628 and a second end 632. The container 620 includes a recess 636 at the first end 628. The container 620 is adapted to receive a plug or a stopper 640 having a recess 644 on an outside surface of the stopper 640. The container 620 can include a plurality of separate chambers 646, as illustrated in FIG. 40, for centrifuging a plurality of samples at the same time.

The centrifuge 600 also includes an actuator 648, such as a motor supported by the housing 604. The actuator 648 includes a rotor or a shaft 652 operable to provide a rotational output from about 1,000 to about 25,000 rpm. The shaft 652 includes an axis 656 oriented in a substantially horizontal plane and oriented to be substantially parallel with respect to the base 608. The centrifuge 600 also includes a wheel 660 coupled to the actuator shaft 652 and extends into the recessed area 616. The centrifuge 600 also includes a flange 664 supported by the housing 604 and positioned a distance from the actuator shaft 652. The flange 664 also extends into the recessed area 616. The flange 664 includes an axis 668 oriented in a substantially horizontal plane and substantially aligned with the axes 624 and 656. The wheel 660 and the flange 664 are adapted to receive the container 620. The wheel 660 is adapted to be received in the recess of the first end 628 of the container 620, and the flange 664 is adapted to be received in the recess 644 of the stopper 640.

The distance between the wheel 660 and the flange 664 is adjustable. The lateral position of the wheel 660 and/or the flange 664 can be adjustable. For example, the wheel 660 and/or the flange 664 can be spring-loaded or toggled to receive and adjust to the length of the container 620. Other mechanisms to adjust the lateral position of the wheel 660 and/or the flange 664 may also be employed.

The centrifuge 600 also includes an activator 672, such as a push button, to initiate the actuator 648. The centrifuge 600 also includes a door or a lid 676 to provide access to the recessed area 616.

The centrifuge 600 can also include a processor 680 or computer and a display 684. The processor 680 is operable to communicate with the actuator 648 and the display 684 and to receive input from the activator 672. The processor 680 can include a software program 688 operable to provide information to the display 684 for display to the user and to provide instructions to the actuator 648. For example, when the user opens the lid 676 of the centrifuge 600, the software program 688 can recognize that the lid 676 has been opened and begin a routine of providing operating instructions to the user. For example, the software program 688 can provide instructions to the display 684 to position the container 620 in the recessed area 616, to close the lid 676, to activate centrifuge process by pressing “start” button 672, and remove container 620 when the centrifuge process is complete. The software program 688 can also generate and provide more or fewer instructions to the display 684 than discussed above.

The centrifuges 500 and 600 described above can be used to form a solid-fibrin web being suitable for regenerating body tissue in a living organism. In preliminary steps blood is collected from a patient in a container 620 and centrifuged to separate red blood cells from platelet-rich plasma. The platelet-rich plasma is removed from the container 620 and placed in a second container 620 and/or moved into a different chamber of the same container 620. The platelet-rich plasma contacts a coagulation activator in the new container 620 or new chamber and is centrifuged in the centrifuge 500, 600 to coagulate the plasma to form the solid-fibrin web.

### EXAMPLE 1

In a 5 ml glass container for antibiotics, being sealable under vacuum, made of transparent white glass, inert and 1 mm thick were introduced 100 mg of tranexamic acid, acting as fibrin stabilizer. The synthetic tranexamic acid, being more than 98% pure, is put on the market by the American Company Sigma Inc. Separately, a 1M CaCl₂ solution was prepared, by weighing on a precision balance 147.0 g of CaCl₂.2H₂0 (>99% pure), from the same American company Sigma Inc.

This salt was dissolved in exactly 1 liter of ultrapure nonpyrogenic distilled water, for a few minutes at room temperature, under frequent stirring. By using a precision piston dispenser, having a dispensing precision of ±5% (Eppendorf like), 80 μL of the activator solution were introduced in the glass container. In this step, at the same time as the dispensing, a filtering was carried out by using a 0.22 μm Millpore sterilizing filter, while carefully preventing possible contamination from powders or filaments of any kind. Finally the glass container was plugged with a rubber cap being pierceable and pluggable under vacuum, while minding not to completely plug the container, so as to allow the subsequent vacuum plugging and possibly a further sterilization by using gas. The container was then introduced into a suitable device for vacuum plugging, while preventing any possible contamination from solid particles in the atmosphere (ULPA or HEPA filtration in sterile chamber). A vacuum as high as 4 ml was applied, by using a membrane vacuum pump and a micrometric control, to the inner atmosphere of the device. In order to control the vacuum level in the inner atmosphere, a precision vacuum gauge was used (precision #1 mbar). Finally, without discharging the device, the container was plugged under vacuum, to be thereafter recovered for the use as described in the following Example.

### EXAMPLE 2

10 ml of venous blood were drawn from a patient according to the provisions of the qualitative standards for clinical analysis, e.g. by using VACUTAINER® sterile test-tubes by Becton-Dickinson, added with a 0.106 M sodium citrate solution. For this purpose also test-tubes added with disodium or dipotassium ethylenediaminetetraacetate can be used. The sample was carefully kept sterile during the blood drawing. Finally, the sample was gently shaken for wholly mixing the components, thereby ensuring the anticoagulating action of sodium citrate. The test-tube was then introduced in a suitable centrifuge, while carefully balancing the rotor weight in order to prevent the same centrifuge to be damaged. Once the lid is sealed, the sample was centrifuged at 3500 rpm for 15 minutes, thereby separating the red cells (being thicker) from the citrated plasma (supernatant). In this case the plasma yield, mainly depending upon the characteristics of the donor blood, was as high as 55%. The test-tube containing the separated plasma was kept plugged in sterile conditions and was placed vertically in a stand for recovering the plasma itself, in this step care was taken not to shake the test-tube, in order to prevent the mixing of the two phases separated in the centrifugation. The outer portion of the test-tube cap was then sterilized by using denatured alcohol and then a sterile needle, being connected to a sterile syringe, was introduced in the test-tube cap. The needle was brought up to 3-4 mm apart from the separating meniscus of the two phases, and 4 ml of plasma were drawn. By using the same needle, the cap of the container according to the present invention, which had been prepared as described in Example 1, was pierced, having been previously sterilized by using alcohol. As soon as the needle pierced the cap, the citrated plasma contained in the syringe was completely sucked into the container. This was gently shaken and, after about 2 minutes at 37° C., a clot of sterile autologous fibrin glue was obtained, ready to be immediately used.

### EXAMPLE 3

About 18 ml of venous blood were drawn from a 49 year-old patient by using 5 ml sodium citrate VACUTAINER® test-tubes by Becton-Dickinson, talking care to shake gently just after the drawing of the sample. The so taken blood was immediately subjected to centrifugation (15 min. at 2500 rpm) to separate the plasma. The plasma (12 ml) was carefully transferred into two 10 ml test-tubes, containing 120 μL of CaCl₂ (10 g/100 ml) each, which had been prepared as described in Example 1, but without using tranexamic acid. After mixing the plasma with the activator, the test-tubes were centrifuged for 30 min. at 3000 rpm, finally obtaining two massive fibrin samples which were inserted, with all sterility precautions, within 2-3 hours from preparation, in the large vesicular mandibular cavity resulting from extraction of impacted left canine and right second incisor, as well as from abscission of the cyst present in the central area of the incisor teeth. Finally the gingival edges were closed with eight stitches. A radiographic check 15 days after showed the fibrin still in its position, apparently intact. Histology 7 months after proved the complete replacement of the fibrin with bony tissue, with a better post-operative course than with traditional methods, requiring over 12 months to achieve the same result. Since no antifibrinolytic agent had been used for the preparation of autologous fibrin, it can be stated in this case that said additive was useful for the specific purpose.

### EXAMPLE 4

To produce an adhesive fibrin glue 12 ml of plasma, obtained as in Example 3, were transferred, with all the measures in order to preserve sterility, into a 20 ml container according to the present invention, prepared as described in Example 1.

After careful stirring, the mixed plasma was poured on a sterile glass slide, of the kind used in chemical laboratories, where the plasma was mixed with sterile and very pure calcium carbonate of coralline origin (BIOCORAL™•NOTEBS S.A. France), or with calcium fluoride (>98% Sigma Inc.). These calcium salts are both well known to the skilled in the art as stimulators of fibroblasts.

By mixing one part of the plasma with one part of calcium carbonate, (e.g.; 2 ml with 500 mg) a malleable, sterile and adhesive paste was obtained and used as a filler for subgingival spaces or different cavities after abscission of infected mucous sacs. The paste, positioned so as to fill the empty spaces, formed in a few minutes a solid fibrin web acting as a haemostatic plug and created an autologous biological substrate supporting the mucous edges in position and where later migration of connectival cells started.

### EXAMPLE 5

To obtain a membrane of fibrin glue 20 ml of plasma, obtained as in Example 3, were put in a 25 ml, flat-bottomed container according to the present invention prepared as in Example 1. After the usual careful stirring, the container was centrifuged for 40 min. at 4000 rpm with a swing-out rotor. At the end of the centrifuging operation, from the bottom of the test tube a white-colored, very compact and tensile-strong membrane was recovered, having the same size as the bottom of the test-tube (24 mm diam.) and thickness of 3 mm. This autologous membrane, owing to its compactness and strength, was used as a holding and separating membrane in dental and general surgery, as a substitute for porous synthetic membranes. The obtained membrane can be stored sterile for several days at 4° C.

### EXAMPLE 6

To obtain large-sized membranes of fibrin glue about 200 ml of citrated plasma were drawn from a patient, collected and separated in a double transfusion bag. The plasma was subjected to cryoprecipitation by freezing at −80° C. for 12 hours, defreezing being carried overnight at 4° C. (this procedure is well known to those skilled in the art). The same morning the plasma obtained by this procedure was subjected to centrifugation for 15 min. at 5000 rpm at 4° C. to obtain about 20 ml of cryoprecipitate. After careful removal of the supernatant by using a pressing device (e.g. XP100 of the company Jouan S.A. France) the cryoprecipitate was taken up with 20 ml of whole plasma of the same patient. The resulting 40 ml were put in a 35 mm diameter, flat-bottomed sterile polypropylene container according to the present invention, containing the suitable quantity of activator, as in Example 1. After careful shaking, the container was centrifuged for 40 min. at 5000 rpm to obtain a membrane as in Example 5, but more compact and tensile-strong owing to the higher content of fibrin. Said membrane too can be stored in sterile form for several days at 4° C.

The membrane obtained by the method described in Example 5, in addition to utilization described in Example 4, can be used as a substrate for the culture in vitro of dermal cells of the same patient, in order to obtain grafts to be transplanted in case of very serious scalds.

Membranes of a good quality useful for the above mentioned purposes can be obtained also from whole separated plasma directly transferred into the container according to the present invention. The obtained membrane will be thinner than the above described one, but still useful for surgical uses and as a substrate for cellular growth.

### EXAMPLE 7

A study was conducted to assess the ability of a novel autologous platelet-rich fibrin membrane (PRFM) to facilitate healing in patients with chronic lower extremity ulcers. An initial report from this study describes the experience with PRFM in the treatment of 14 patients with a variety of non-healing ulcers including neuropathic diabetic foot ulcers, traumatic wounds, arterial ulcer and mixed etiology ulcers (arterial-diabetic, arterial-venous). The report also presents preliminary data from a prospective, randomized, controlled, 30-patient trial comparing PRFM with standard compression therapy versus standard compression therapy alone in patients with venous leg ulcers (VLU). For all patients, ulcers were greater than one month duration at time of treatment. All patients were evaluated for arterial and venous blood flow and surgical intervention to achieve adequate perfusion and venous return was performed as needed prior to enrollment. Each PRFM-treated patient received up to three applications of a 50 mm fenestrated membrane under an IRB approved protocol. The principal endpoint was complete closure (100% epithelialization in the absence of drainage) as measured by digital photography, computerized planimetery and clinical examination. A secondary endpoint was the rate of wound closure. The membrane was prepared at bedside from 36 mL of whole blood from which platelet-rich plasma was isolated, re-calcified and centrifuged at high speed to produce a strong, drapable 100 μm-thick membrane without the use of exogenous thrombin, collagen, adenosine diphosphate or other clot activator. Patients received an initial treatment and were followed at weekly intervals out to 12 weeks. At week four, the extent of healing was assessed—patient with greater than 50% reduction in wound area were allowed to continue to complete closure with good wound care, patient with less than 50% closure received a second application. A second assessment and possible third application was performed at week eight.

The study demonstrated that ulcer size in the treated patients ranged from 1.5 cm² to >65 cm², ulcer duration ranged from one month to 53 years. Complete closure, at time of writing the study results, was achieved in 63% of the VLU patients and 57% of the other ulcer patients

What is claimed is:

1. A centrifuge comprising:
a base supportable on a surface;
a roller supported by the base and arranged to receive a container, the roller defines an axis oriented substantially parallel with respect to the base; and
an actuator operable to actuate the roller to rotate the container.

2. The centrifuge of claim 1, wherein the roller is in contact with the container.

3. The centrifuge of claim 1, further comprising a plurality of rollers.

4. The centrifuge of claim 3, wherein each of the rollers includes an axis oriented substantially parallel with respect to the base.

5. The centrifuge of claim 3, wherein the base and the rollers have a substantially horizontal arrangement.

6. The centrifuge of claim 5, wherein at least one of the rollers is in contact with the container.

7. The centrifuge of claim 6 further comprising a sleeve adapted to receive the container, the sleeve being in contact with at least one of the rollers, the sleeve including an axis oriented substantially horizontally with respect to the base.

8. The centrifuge of claim 7, wherein the actuator is coupled to the sleeve to rotate the sleeve.

9. The centrifuge of claim 8, wherein the actuator includes a shaft coupled to at least one of the rollers.

10. The centrifuge of claim 9, wherein the actuator includes a shaft coupled to a first wheel, and wherein at least one of the rollers includes a shaft coupled to a second wheel, and further comprising an elastic member coupled to the first wheel and the second wheel.

11. The centrifuge of claim 10, wherein the actuator drives at least two of the rollers.

12. A method of preparing a solid-fibrin web, the method comprising:
separating plasma from blood with a first centrifuge;
contacting the plasma with a coagulation activator in a container; and
activating a roller supported by a second centrifuge to concurrently rotate the container and coagulate the plasma to form the solid-fibrin web, the solid-fibrin web being suitable for regenerating body tissue in a living organism, the container being arranged in a substantially horizontal plane.

13. The method of claim 12, wherein the coagulation activator is selected from calcium chloride, calcium fluoride, calcium carbonate and combinations thereof.

14. The method of claim 12 further comprising the act of contacting the blood with an anticoagulant before separating plasma from the blood.

15. The method of claim 14, wherein the anticoagulant is selected from sodium citrate, ethylenelendiaminetetraacetic acid disodium salt, ethylenelendiaminetetraacetic acid dipotassium salt and combinations thereof.

16. The method of claim 12 further comprising removing the plasma from the blood and placing the plasma in a second container having the calcium-coagulation activator.

17. A centrifuge comprising:
a housing including a recessed area and a base supportable on a surface;
an actuator;
a wheel coupled to the actuator, the wheel extending into the recessed area and adapted to contact a first end of a container; and
a flange extending into the recessed area opposite the wheel and defining an adjustable distance between the wheel and the flange, the flange adapted to contact a second end of the container, the actuator operable to rotate the container, the container oriented substantially parallel with respect to the base.

18. The centrifuge of claim 17 wherein the wheel, the flange, and the container define a continuous axis.

19. The centrifuge of claim 17 wherein the one of the wheel and the flange are spring-loaded.

20. The centrifuge of claim 17 further comprising a processor supported by the housing, the processor operable to provide instructions to a user of the centrifuge.
